(19) United States
(12) Patent Application Publication
(10) Pub. No.: US 2023/0387510 A1
(43) Pub. Date: Nov. 30, 2023

(54) Metal Air Battery

(71) Applicant: Nippon Telegraph and Telephone Corporation, Tokyo (JP)

(72) Inventors: Yuzu Kobayashi, Musashino-shi, Tokyo (JP); Hiroaki Taguchi, Musashino-shi, Tokyo (JP); Masaya Nohara, Musashino-shi, Tokyo (JP); Mikayo Iwata, Musashino-shi, Tokyo (JP); Takeshi Komatsu, Musashino-shi, Tokyo (JP)

(21) Appl. No.: 18/248,964

(22) PCT Filed: Oct. 28, 2020
(86) PCT No.: PCT/JP2020/040518

§ 371 Date: Apr. 13, 2023

(51) Int. Cl. H01M 12/06; H01M 4/46; H01M 4/583; H01M 50/497; H01M 12/02

(52) U.S. Cl. CPC H01M 12/06; H01M 4/466; H01M 4/583; H01M 50/497; H01M 12/02; H01M 2004/027

(57) ABSTRACT

A metal-air battery includes an air electrode, a negative electrode, and an electrolytic solution disposed between the air electrode and the negative electrode, and the electrolytic solution contains an alkyl glucoside having or more and or less carbon atoms.

### TECHNICAL FIELD

The present invention relates to a metal-air battery.

### BACKGROUND ART

Conventionally, alkaline batteries, manganese batteries, and the like have been widely used as disposable primary batteries. In addition, in recent years, with the development of the Internet of Things (IoT), the development of deployed sensors to be installed and used in any place in nature such as in the soil or in the forests has also progressed, and small and high-performance coin-type lithium primary batteries corresponding to various applications such as these sensors have become widespread.

However, disposable batteries generally used at present are often composed of rare metal metals such as lithium, nickel, manganese, and cobalt, and there is a problem of resource depletion. In addition, since a strongly alkaline electrolytic solution such as a sodium hydroxide aqueous solution or an organic electrolytic solution is used as the electrolytic solution, there is a problem that final disposal is not easy. In addition, in a case where a disposable battery is used as a drive source of a sensor to be embedded in soil, there is a concern about an influence on the surrounding environment depending on the use environment.

In order to solve the problems as described above, a metal-air battery can be mentioned as a candidate that can be a battery having a low environmental load. In the metal-air battery, oxygen and water are used as the air electrode active material, and a metal such as magnesium, aluminum, calcium, iron, or zinc is used as the negative electrode active material, and thus the influence on soil contamination and the like and the influence on an ecosystem are also low. In addition, these are materials with abundant resources, and are inexpensive as compared with rare metals. Such a metal-air battery has been researched and developed as a battery having a low environmental load (see Patent Literature 1).

### CITATION LIST

### Patent Literature

Patent Literature 1: WO 2018/003724 A

### Non Patent Literature

Non Patent Literature 1: M. A. Deyab, “Decyl glucoside as a corrosion inhibitor for magnesiumeair batter”, Journal of Power Sources, vol. 325, pp. 98-103, 2016.
Non Patent Literature 2: Salah Eid, “Measurement of Hydrogen Produced during Magnesium Corrosion in Hydrochloric Acid and the Effect of the TritonX-100 Surfactant on Hydrogen Production”, J Surfact Deterg, vol. 22, pp. 153-160, 2019.

### SUMMARY OF INVENTION

### Technical Problem

In a metal-air battery, the metal of the negative electrode is consumed with the passage of time by corrosion reactions, and only a part of the input metal can be used for the battery reaction. It has been reported that a corrosion reaction of a metal can be suppressed by adding a surfactant to an electrolytic solution (see Non Patent Literature 1 and 2).

However, the surfactant of this non patent literature has a limit in a corrosion suppressing effect, and a surfactant having a larger corrosion suppressing effect is required for improving a discharge capacity.

The present invention has been made in view of the above circumstances, and an object of the present invention is to suppress a corrosion reaction of a negative electrode and to improve a discharge capacity of a metal-air battery.

### Solution to Problem

A metal-air battery according to one aspect of the present invention includes: an air electrode; a negative electrode; and an electrolytic solution disposed between the air electrode and the negative electrode, and the electrolytic solution contains an alkyl glucoside having 18 or more and 22 or less carbon atoms.

### Advantageous Effects of Invention

According to the present invention, the corrosion reaction of the negative electrode can be suppressed, and the discharge capacity of the metal-air battery can be improved.

### BRIEF DESCRIPTION OF DRAWINGS

FIG. 1 is a diagram illustrating a basic configuration of a metal-air battery according to an embodiment of the present invention.

FIG. 2 is a diagram illustrating a basic configuration of another metal-air battery according to the embodiment of the present invention.

FIG. 3 is a flowchart for describing Manufacturing Method 1.

FIG. 4 is a flowchart for describing Manufacturing Method 2.

FIG. 5 is a flowchart for describing Manufacturing Method 3.

FIG. 6 is a flowchart for describing Manufacturing Method 4.

FIG. 7 is a flowchart for describing Manufacturing Methods 5, 6, and 7.

FIG. 8A is a cross-sectional view illustrating a configuration example of a coin cell type of the metal-air battery illustrated in FIG. 1.

FIG. 8B is a plan view illustrating a configuration example of a coin cell type of the metal-air battery illustrated in FIG. 1.

FIG. 9A is a cross-sectional view illustrating a configuration example of a coin cell type of the metal-air battery illustrated in FIG. 2.

FIG. 9B is a plan view illustrating a configuration example of a coin cell type of the metal-air battery illustrated in FIG. 2.

FIG. 10 is a configuration diagram illustrating a configuration example of the metal-air battery of FIG. 1.

FIG. 11 is a configuration diagram illustrating a configuration example of the metal-air battery of FIG. 2.

FIG. 12 is a graph illustrating a discharge curve in Example 1.

### DESCRIPTION OF EMBODIMENTS

Hereinafter, an embodiment of the present invention will be described with reference to the drawings.

Configuration of Metal-Air Battery

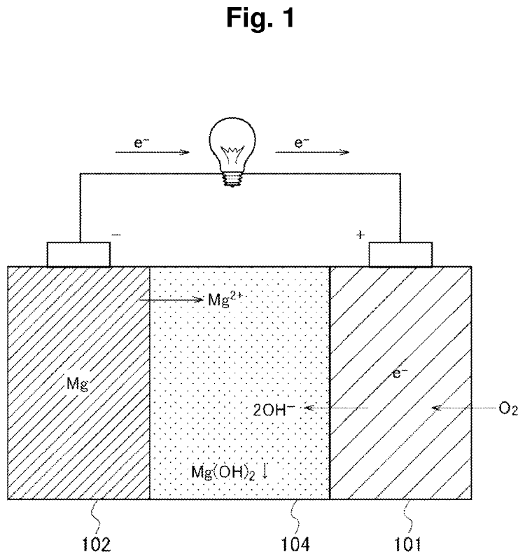

FIG. 1 is a configuration diagram illustrating a basic configuration of a metal-air battery in the present embodiment. In FIG. 1, a metal-air battery using magnesium for the negative electrode is illustrated as an example, but the present invention is not limited to the magnesium-air battery.

The metal-air battery illustrated in FIG. 1 includes a positive electrode and a gas diffusion type air electrode 101, a negative electrode 102, and an electrolytic solution 104 disposed between the air electrode 101 and the negative electrode 102. One surface of the air electrode 101 is exposed to the atmosphere, and the other surface is in contact with the electrolytic solution 104. A surface of the negative electrode 102 on the electrolytic solution 104 side is in contact with the electrolytic solution 104.

In the electrolytic solution 104, an alkyl glucoside is dissolved as a surfactant. The electrolytic solution 104 of the present embodiment contains an alkyl glucoside having 18 or more and 22 or less carbon atoms. The number of carbon atoms is the number of carbon atoms in the whole molecule. The number of carbon atoms of the alkyl glucoside includes, for example, the number of carbon atoms of the alkyl group. Alkyl glucosides are nonionic surfactants.

The concentration of the alkyl glucoside is preferably 1×10⁻¹ to 1×10⁻⁶ mol/L. An alkyl glucoside having 24 or more carbon atoms is not preferable because it has low hydrophilicity and a saturated concentration of less than 1×10⁻⁶ mol/L.

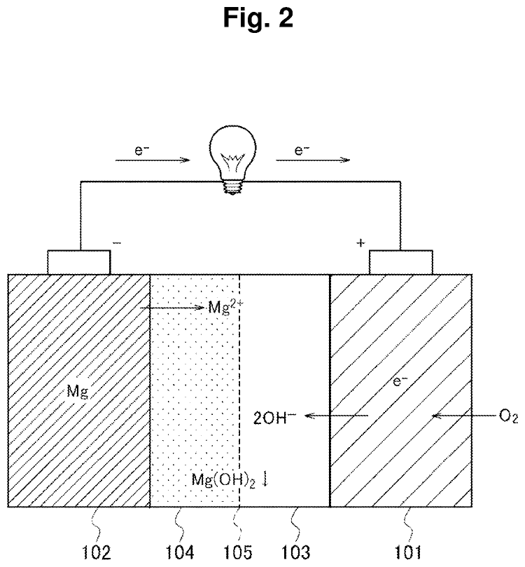

FIG. 2 is a configuration diagram illustrating a basic configuration of another metal-air battery in the present embodiment. In FIG. 2, a metal-air battery using magnesium for the negative electrode is illustrated as an example, but the present invention is not limited to a magnesium-air battery.

The metal-air battery illustrated in FIG. 2 includes a positive electrode and a gas diffusion type air electrode 101, a negative electrode 102, an electrolytic solution 103 on the air electrode side, an electrolytic solution 104 on the negative electrode side, and an ion exchange membrane 105. The ion exchange membrane 105 separates the electrolytic solution into the electrolytic solution 103 on the air electrode side and the electrolytic solution 104 on the negative electrode side. The electrolytic solution 103 is disposed between the air electrode 101 and the ion exchange membrane 105. The electrolytic solution 104 is disposed between the negative electrode 102 and the ion exchange membrane 105.

The above-mentioned alkyl glucoside having 18 or more and 22 or less carbon atoms is contained in the electrolytic solution 104 on the negative electrode side. That is, the alkyl glucoside is dissolved in the electrolytic solution 104. On the other hand, the electrolytic solution 103 on the air electrode side does not contain an alkyl glucoside. The ion exchange membrane 105 suppresses diffusion of the alkyl glucoside (surfactant) and separates the electrolytic solution 103 on the air electrode side from the electrolytic solution 104 on the negative electrode side.

Hereinafter, the air electrode 101, the negative electrode 102, the electrolytic solutions 103 and 104, and the ion exchange membrane 105 of the present embodiment illustrated in FIGS. 1 and 2 will be described.

(Air Electrode)

First, the air electrode 101 will be described. The air electrode 101 of the present embodiment includes a co-continuous body having a three-dimensional network structure in which a plurality of nanostructures are integrated by non-covalent bonds. The co-continuous body is a porous body and has an integral structure.

The nanostructure is, for example, a nanosheet, a nanofiber, or the like. In a co-continuous body having a three-dimensional network structure in which a plurality of nanostructures are integrated by non-covalent bonds, a bonding portion between the nanostructures is deformable, and the co-continuous body has a stretchable structure.

The nanosheet may contain, for example, at least one selected from the group consisting of carbon, iron oxide, manganese oxide, magnesium oxide, molybdenum oxide, and molybdenum sulfide compound. Examples of the molybdenum sulfide compound include molybdenum disulfide and phosphorus-doped molybdenum sulfide. The elements of the material of the nanosheet may be any elements as long as it contains at least one of the 16 kinds of essential element (C, O, H, N, P, K, S, Ca, Mg, Fe, Mn, B, Zn, Cu, Mo, Cl) essential for the growth of plants.

It is important that the nanosheets have conductivity. A nanosheet is defined as a sheet-like substance having a thickness of 1 nm to 1 μm and a planar longitudinal and lateral length of 100 times or more the thickness. For example, graphene is a carbon nanosheet. The nanosheet may have a roll shape or a wave shape, or the nanosheet may be curved or bent, or may have any shape.

The nanofiber may contain at least one selected from the group consisting of carbon, iron oxide, manganese oxide, magnesium oxide, molybdenum oxide, molybdenum sulfide, and cellulose (carbonized cellulose). The elements of these materials may be any element as long as they contain at least one of the 16 kinds of essential element (C, O, H, N, P, K, S, Ca, Mg, Fe, Mn, B, Zn, Cu, Mo, Cl) essential for growth of plants.

It is important that the nanofibers also have conductivity. The nanofiber is defined as a fibrous substance having a diameter of 1 nm to 1 μm and a length of 100 times or more the diameter. In addition, the nanofiber may have a hollow shape, a coil shape, or any shape. As described later, cellulose is used by being carbonized to have conductivity.

For example, the sol or gel in which the nanostructures are dispersed is frozen to obtain a frozen body (freezing step), and the frozen body is dried in vacuum (drying step), thereby making it possible to produce a co-continuous body serving as the air electrode 101. Any gel in which nanofibers containing at least one of iron oxide, manganese oxide, silicon, and cellulose are dispersed can be produced by predetermined bacteria (gel production step).

In addition, a gel in which nanofibers made of cellulose are dispersed may be produced by predetermined bacteria (gel production step), and this gel may be carbonized by heating in an inert gas atmosphere to obtain a co-continuous body (carbonization step).

The co-continuous body constituting the air electrode 101 preferably has an average pore size of 0.1 to 50 μm, and more preferably 0.1 to 2 μm, for example. Here, the average pore size is a value obtained by a mercury intrusion method.

In the air electrode 101 using such a co-continuous body, an additional material such as a binder required in the case of an air electrode using carbon powder is unnecessary, which is advantageous in terms of cost and environment.

(Negative Electrode)

Next, the negative electrode 102 will be described. The negative electrode 102 contains at least one selected from the group consisting of magnesium, zinc, aluminum, iron, and calcium. Specifically, the negative electrode 102 is made of a negative electrode active substance. The negative electrode active substance is not particularly limited as long as it is a material that can be used as a negative electrode material of a metal-air battery, that is, at least one metal selected from the group consisting of magnesium, zinc, aluminum, iron, and calcium. The negative electrode active substance may be an alloy containing at least one metal selected from the group as a main component. For example, the negative electrode 102 may be made of a metal serving as a negative electrode, a sheet of metal, or a material obtained by pressure-bonding powder to a metal foil such as copper.

The negative electrode 102 can be formed by a known method. For example, when magnesium metal is used as the negative electrode 102, the negative electrode 102 can be produced by forming a plurality of metal magnesium foils in a predetermined shape in an overlapping manner.

(Electrolytic Solution)

Next, the electrolytic solution will be described. The electrolytic solution 103 on the air electrode side illustrated in FIG. 2 may be a gel electrolytic solution containing an ion conductor capable of moving hydroxide ions between the air electrode 101 (positive electrode) and the negative electrode 102. As the ion conductor constituting the electrolytic solution 103, for example, a metal salt containing potassium or sodium abundantly present on the earth can be used. The metal salt may be composed of the 16 kinds of essential element (C, O, H, N, P, K, S, Ca, Mg, Fe, Mn, B, Zn, Cu, Mo, Cl) essential for growth of plants, elements contained in seawater or rainwater, and the like.

The electrolytic solution 103 may be composed of using, for example, at least one selected from the group consisting of chloride such as sodium chloride and potassium chloride, acetate, carbonate, citrate, phosphate, HEPES (4-(2-hydroxyethyl)-1-piperazineethanesulfonic acid), pyrophosphate, and metaphosphate. It may also be composed of a mixture thereof. The ion conductor can be dissolved in ion-exchanged water at a concentration of 0.1 to 10 mol/L, preferably at a concentration of 0.1 to 2 mol/L to form the electrolytic solution 103.

The electrolytic solution 104 illustrated in FIG. 1 and the electrolytic solution 104 on the negative electrode side illustrated in FIG. 2 are obtained by dissolving an alkyl glucoside having 18 or more and 22 or less carbon atoms in the same solution (that is, the electrolytic solution 103) as the electrolytic solution 103 at a concentration of 1×10⁻⁵ to 1 mol/L. Alkyl glucosides are nonionic surfactants that are considered to be less likely to affect battery reactions. By dissolving the alkyl glucoside, the corrosion reaction of the negative electrode 102 can be suppressed, and the battery performance is improved.

(Ion Exchange Membrane)

The ion exchange membrane 105 illustrated in FIG. 2 separates the electrolytic solution into the electrolytic solution 103 on the air electrode side and the electrolytic solution 104 on the negative electrode side. That is, the ion exchange membrane 105 is disposed so as to separate the electrolytic solution 103 and the electrolyte 104. Various materials can be used for the ion exchange membrane 105. For example, the ion exchange membrane 105 preferably contains at least two selected from the group consisting of a carbon atom, a hydrogen atom, an oxygen atom, a nitrogen atom, a sulfur atom, a sodium atom, a potassium atom, and a phosphorus atom. The ion exchange membrane 105 of the present embodiment allows permeation of only hydroxide ions and suppresses diffusion (movement) of alkyl glucoside contained in the electrolyte 104 into the electrolytic solution 104 on the air electrode side.

In the present embodiment, an alkyl glucoside is added only to the electrolytic solution 104 on the negative electrode side, and an ion exchange membrane 105 that suppresses diffusion of the alkyl glucoside between the electrolytic solution 104 and the electrolytic solution 103 on the air electrode side is provided. Thereby, in the present embodiment, it is possible to prevent the alkyl glucoside from diffusing into the electrolytic solution 103 on the air electrode side, hydrophilizing the air electrode 101, submerging the air electrode 101 in the electrolyte 103, and lowering the battery voltage.

(Other Elements)

In addition to the above configuration, the metal-air battery can include structural members such as a separator, a battery case, and a metal mesh (for example, copper mesh), and elements required for the metal-air battery. As these, conventionally known ones can be used. The separator is not particularly limited as long as it is a fiber material, but a cellulose-based separator made of plant fibers or bacteria is particularly preferable.

Manufacturing Method

Next, a method for manufacturing a metal-air battery will be described. The metal-air battery of the present embodiment can be produced by appropriately disposing the air electrode 101, the negative electrode 102, the electrolytic solutions 103 and 104, and the ion exchange membrane 105 in a suitable container such as a case, together with other necessary elements based on the desired metal-air battery structure. Conventionally known methods can be applied to the manufacturing procedure of these metal-air batteries.

Hereinafter, a method for producing the electrolytic solutions 103 and 104 and the air electrode 101 will be described.

Manufacturing Method 1 (Manufacturing Method of Electrolytic Solution)

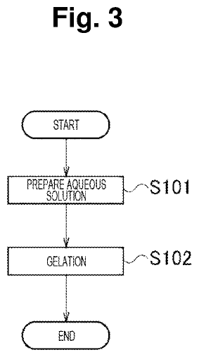

First, Manufacturing Method 1 of the electrolytic solution 103 on the positive electrode side in FIG. 2 will be described with reference to FIG. 3.

FIG. 3 is a flowchart for describing Manufacturing Method 1. First, in step S101, the ion conductor of the electrolyte is dissolved in ion-exchanged water to prepare an aqueous solution. Next, in step S102, a gelling agent is added to the adjusted aqueous solution. As the gelling agent, plant-derived polysaccharides (corn starch, potato starch, tapioca starch, dextrin, tamarin seed gum, guar gum, locust bean gum, gum arabic, karaya gum, pectin, cellulose, konjac-mannan, soybean polysaccharide), seaweed-derived polysaccharides (carrageenan, agar, alginic acid), microorganism-derived polysaccharides (xanthan gum, gellan gum, agrobacterium succinoglycan, cellulose), animal-derived polysaccharides (chitin, chitosan, gelatin), and the like can be used.

The weight % of the gelling agent may be 0.01 to 90%, preferably 0.01 to 20% with respect to the aqueous solution of the ionic conductor. The ion conductor may be composed of one or more of chloride, acetate, carbonate, citrate, phosphate, HEPES (4-(2-hydroxyethyl)-1 piperazineethanesulfonic acid), pyrophosphate, and metaphosphate.

When the gelling agent is added to a solvent at about 50° C. to 90° C., molecules of the gelling agent sufficiently swell and disperse, and as the temperature of the solvent decreases, the molecules are entangled with each other to form a crosslinking point. As many crosslinking points are formed, the gelling agent has a network-shaped structure, and the solvent becomes a gel. The dissolution temperature (50 to 90° C.) required to dissolve the gelling agent and the cooling temperature (10 to 80° C.) required for gelation vary depending on the gelling agent used.

The electrolytic solution 104 in FIGS. 1 and 2 is produced by dissolving an alkyl glucoside having 18 or more and 22 or less carbon atoms in an electrolytic solution manufactured in the same manner as the electrolytic solution 103.

Manufacturing Method 2 (Manufacturing Method of Air Electrode)

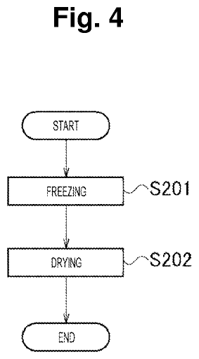

Next, Manufacturing Method 2 of the air electrode 101 will be described with reference to FIG. 4.

FIG. 4 is a flowchart for describing Manufacturing Method 2. First, in step S201, a sol or gel in which a nanostructure such as a nanosheet or a nanofiber is dispersed is frozen to obtain a frozen body (freezing step). Next, in step S202, the obtained frozen body is dried in vacuum to obtain a co-continuous body (drying step). Hereinafter, each step will be described in more detail.

The freezing step in step S201 is a step of maintaining or constructing a three-dimensional network structure using a nanostructure serving as a raw material of a co-continuous body having stretchability. A co-continuous body has a three-dimensional network structure in which a plurality of nanostructures are integrated by non-covalent bonds.

Here, the gel means a solid in which the nanostructure in which the dispersion medium is a dispersoid loses fluidity due to the three-dimensional network structure. Specifically, it means a dispersion having a shear modulus of 10² to 10⁶ Pa. The dispersion medium of the gel is an aqueous system such as water (H₂O), or an organic system such as carboxylic acid, methanol (CH₃OH), ethanol (C₂H₅OH), propanol (C₃H₇OH), n-butanol, isobutanol, n-butylamine, dodecane, unsaturated fatty acid, ethylene glycol, heptane, hexadecane, isoamyl alcohol, octanol, isopropanol, acetone, or glycerin, and two or more kinds thereof may be mixed.

Next, the sol means a colloid including a dispersion medium and a nanostructure which is a dispersoid. Specifically, it means a dispersion having a shear modulus of 1 Pa or less. The dispersion medium of the sol is an aqueous system such as water, or an organic system such as carboxylic acid, methanol, ethanol, propanol, n-butanol, isobutanol, n-butylamine, dodecane, unsaturated fatty acid, ethylene glycol, heptane, hexadecane, isoamyl alcohol, octanol, isopropanol, acetone, or glycerin, and two or more kinds thereof may be mixed.

The freezing step is performed, for example, by storing the sol or gel in which the nanostructures are dispersed in an appropriate container such as a test tube and cooling the periphery of the test tube in a coolant such as liquid nitrogen to freeze the sol or gel stored in the test tube. The method for freezing is not particularly limited as long as the dispersion medium of the gel or sol can be cooled to a temperature equal to or lower than the solidifying point, and the dispersion medium may be cooled in a freezer or the like.

By freezing the gel or sol, the dispersion medium loses fluidity, the dispersoid is fixed, and a three-dimensional network structure is constructed. In the freezing step, the specific surface area can be freely adjusted by adjusting the concentration of the gel or sol, and the lower the concentration of the gel or sol, the higher the specific surface area of the resulting co-continuous body. However, when the concentration is 0.01 weight % or less, it is difficult for the dispersoid to construct a three-dimensional network structure, and thus the concentration of the dispersoid is preferably 0.01 to 10 weight % or less.

By constructing a three-dimensional network structure having a high specific surface area with nanostructures such as nanofibers or nanosheets, pores serve as a cushion during compression or tension, and have excellent stretchability. Specifically, the co-continuous body desirably has a strain at an elastic limit of 5% or more, and more desirably has 10% or more.

When the dispersoid is not fixed by the freezing step, in the subsequent drying step, the dispersoid is aggregated with the evaporation of the dispersion medium, so that a sufficient high specific surface area cannot be obtained, and it is difficult to produce a co-continuous body having a three-dimensional network structure.

Next, the drying step in step S202 will be described. The drying step is a step of taking out, from the dispersion medium, the dispersoid (a plurality of integrated fine structures) maintaining or constructing the three-dimensional network structure from the frozen body obtained in the freezing step.

In the drying step, the frozen body obtained in the freezing step is dried in vacuum, and the frozen dispersion medium is sublimated from a solid state. The drying step is performed, for example, by storing the obtained frozen body in an appropriate container such as a flask and vacuuming the inside of the container. By disposing the frozen body in a vacuum atmosphere, the sublimation point of the dispersion medium is lowered, and even a substance that is not sublimated at normal pressure can be sublimated.

The degree of vacuum in the drying step varies depending on the dispersion medium to be used, but is not particularly limited as long as it is the degree of vacuum at which the dispersion medium sublimates. For example, when water is used as the dispersion medium, it is necessary to set the degree of vacuum to a pressure of 0.06 MPa or less, but since heat is removed as latent heat of sublimation, it takes time for drying. Therefore, the degree of vacuum is preferably 1.0×10⁻⁶ to 1.0×10⁻² Pa. Furthermore, heat may be applied using a heater or the like during drying.

In the method for drying in the atmosphere, the dispersion medium changes from a solid to a liquid, and then changes from the liquid to a gas, and thus the frozen body becomes a liquid state and becomes fluid again in the dispersion medium, and the three-dimensional network structure of the plurality of nanostructures collapses. Therefore, it is difficult to produce a co-continuous body having stretchability by drying in an atmospheric pressure atmosphere.

When the nanostructure is a cellulose nanofiber, a carbonization step (not illustrated) is performed, and the co-continuous body obtained in the drying step is carbonized to impart conductivity. On the other hand, when the nanostructure is not a cellulose nanofiber, the carbonization step is not required.

The carbonization of the co-continuous body may be performed by calcining at 200° C. to 2000° C., and more preferably 600° C. to 1800° C. in an inert gas atmosphere. The gas in which the cellulose nanofiber is not burned may be, for example, an inert gas such as nitrogen gas or argon gas. In addition, the gas may be a reducing gas such as hydrogen gas or carbon monoxide gas, or may be carbon dioxide gas.

Manufacturing Method 3 (Manufacturing Method of Air Electrode)

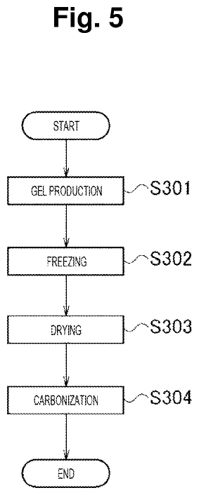

Next, another Manufacturing Method 3 of the air electrode 101 will be described with reference to FIG. 5.

FIG. 5 is a flowchart for describing Manufacturing Method 3. First, in step S301, a gel in which nanofibers of any of iron oxide, manganese oxide, and cellulose are dispersed is produced in predetermined bacteria (gel production step). Using the gel thus obtained, a co-continuous body is produced.

The gel produced by bacteria has a fiber of nm order as a basic structure, and when a co-continuous body is produced using this gel, the resulting co-continuous body has a high specific surface area. As described above, since it is desirable that the air electrode of the metal-air battery have a high specific surface area, it is preferable to use a gel produced by bacteria. Specifically, by using a gel produced by bacteria, it is possible to synthesize an air electrode (co-continuous body) having a specific surface area of 300 m²/g or more.

Since the bacteria-produced gel has a structure in which fibers are entangled in a coil shape or a network shape, and further has a structure in which nanofibers are branched on the basis of growth of bacteria, the co-continuous body that can be produced realizes excellent stretchability in which the strain at the elastic limit is 50% or more. Therefore, the co-continuous body produced using the bacteria-produced gel is suitable for the air electrode of the metal-air battery.

As the bacteria-produced gel, two or more kinds among bacterial cellulose, iron oxide, and manganese oxide may be mixed.

The bacteria include known bacteria, and may be, for example, acetic acid bacteria such as Acetobacter xylinum subspeecies scrofermenter, Acetobacter xylinum ATCC 23768, Acetobacter xylinum ATCC 23769, Acetobacter pasteuranus ATCC 10245, Acetobacter xylinum ATCC 14851, Acetobacter xylinum ATCC 11142, and Acetobacter xylinum ATCC 10821, Agrobacterium, Rhizobium, Sarsina, Pseudomonas, Acromobacterium, Alcaligenes, Aerobacter, Azotobacter, Zooglare, Enterobacter, Klebella, Leptothrix, Galinella, Siderocapsa, Thiobacillus, and the like, and those produced by culturing various mutant strains created by mutating these by a known method using NTG (nitrosoguanidine) or the like.

As a method for obtaining a co-continuous body using the gel produced by bacteria described above, similarly to Manufacturing Method 2, it is only required to freeze the gel in step S302 to obtain a frozen body (freezing step) and to dry the frozen body in vacuum in step S303 to obtain a co-continuous body (drying step). However, in the case of using a gel in which nanofibers made of cellulose produced by bacteria are dispersed, in step S304, the produced co-continuous body is heated and carbonized in an atmosphere of a gas in which cellulose is not burned (carbonization step).

Bacterial cellulose, which is a component contained in the bacteria-produced gel, does not have conductivity. Therefore, when the bacteria-produced gel is used as an air electrode, it is important to perform a carbonization step in which the bacteria-produced gel is carbonized by heat treatment in an inert gas atmosphere to impart conductivity. The co-continuous body carbonized in this way has high conductivity, corrosion resistance, high stretchability, and a high specific surface area, and is suitable as an air electrode of a metal-air battery.

The carbonization of bacterial cellulose may be performed by synthesizing a co-continuous body having a three-dimensional network structure formed of bacterial cellulose by the above-described freezing step and drying step, and then calcining the co-continuous body at 500° C. to 2000° C., and more preferably 900° C. to 1800° C. in an inert gas atmosphere to carbonize the co-continuous body. The gas in which the cellulose is not burned may be, for example, an inert gas such as nitrogen gas or argon gas. In addition, the gas may be a reducing gas such as hydrogen gas or carbon monoxide gas, or may be carbon dioxide gas. In the present embodiment, carbon dioxide gas or carbon monoxide gas which has an activation effect on the carbon material and can be expected to highly activate the co-continuous body is more preferable.

Hereinafter, a method for supporting the catalyst on the air electrode 101 will be described in Manufacturing Methods 4 to 7.

Manufacturing Method 4 (Method for Supporting Catalyst on Air Electrode)

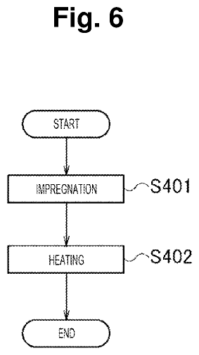

Next, Manufacturing Method 4, which is a method for supporting a catalyst on the air electrode 101, will be described with reference to FIG. 6.

FIG. 6 is a flowchart for describing Manufacturing Method 4. A catalyst may be supported on the air electrode 101. In step S401, the co-continuous body obtained by the above-described Manufacturing Method 2 or Manufacturing Method 3 is impregnated with an aqueous solution of a metal salt to be a precursor of a catalyst (impregnation step). After the stretchable co-continuous body containing the metal salt is prepared in this manner, next, in step S402, the stretchable co-continuous body containing the metal salt may be heat-treated (heating step). A preferred metal of the metal salt to be used is at least one metal selected from the group consisting of iron, manganese, zinc, copper, and molybdenum. In particular, manganese is preferable.

In order to support the transition metal oxide on the co-continuous body, a conventionally known method can be used. For example, there is a method in which a co-continuous body is impregnated with an aqueous solution of a transition metal chloride or a transition metal nitrate, evaporated to dryness, and then subjected to hydrothermal synthesis in water (H₂O) at a high temperature and a high pressure. In addition, there is a precipitation method in which a co-continuous body is impregnated with an aqueous solution of a transition metal chloride or a transition metal nitrate, and an aqueous alkali solution is added dropwise thereto. In addition, there is a sol-gel method in which a co-continuous body is impregnated with a transition metal alkoxide solution and hydrolyzed. The conditions of each method by these liquid phase methods are known, and these known conditions can be applied. In the present embodiment, a liquid phase method is desirable.

In many cases, the metal oxide supported by the liquid phase method is in an amorphous state because crystallization has not progressed. A crystalline metal oxide can be obtained by subjecting the precursor in an amorphous state to a heat treatment in an inert atmosphere at a high temperature of about 500° C. Such a crystalline metal oxide exhibits high performance even when used as a catalyst for an air electrode.

On the other hand, the precursor powder obtained by drying the amorphous precursor at a relatively low temperature of about 100 to 200° C. is in a hydrate state while maintaining an amorphous state. The hydrate of the metal oxide can be formally expressed as MexOy·nH₂O (where Me means the above metal, x and y each represents the number of metal and oxygen contained in the metal oxide molecule, and n represents the number of moles of H₂O with respect to 1 mole of metal oxide). The hydrate of the metal oxide obtained by such low-temperature drying can be used as a catalyst.

Since the amorphous metal oxide (hydrate) is hardly sintered, it has a large surface area and a very small particle size of about 30 nm. This is suitable as a catalyst, and by using this, excellent battery performance can be obtained.

As described above, the crystalline metal oxide exhibits high activity, but the surface area of the metal oxide crystallized by the high temperature heat treatment as described above may be significantly reduced, and the particle size may also be about 100 nm due to aggregation of particles. The particle size (average particle size) is a value obtained by enlarging the particle size and observing the particle size with a scanning electron microscope (SEM) or the like, measuring the diameter of the particle per 10 μm square (10 μm×10 μm), and calculating the average value.

In addition, particularly in the case of a catalyst based on a metal oxide subjected to a heat treatment at a high temperature, particles aggregate, and thus it may be difficult to add the catalyst to the surface of the co-continuous body with high dispersion. In order to obtain a sufficient catalytic effect, it may be necessary to add a large amount of metal oxide in the air electrode (co-continuous body), and the production of a catalyst by heat treatment at a high temperature may be disadvantageous in terms of cost.

In order to solve this problem, the following Manufacturing Method 5, Manufacturing Method 6, and Manufacturing Method 7 may be used.

Manufacturing Method 5 (Method for Supporting Catalyst on Air Electrode)

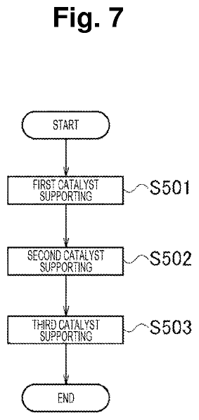

Next, Manufacturing Method 5, which is a method for supporting a catalyst on an air electrode, will be described with reference to FIG. 7.

FIG. 7 is a flowchart for describing Manufacturing Methods 5, 6, and 7. In Manufacturing Method 5, a catalyst is supported on the co-continuous body produced by Manufacturing Method 2 or Manufacturing Method 3. In Manufacturing Method 5, in addition to the manufacture of the co-continuous body described above, the following catalyst supporting step of supporting a catalyst is added.

First, in a first catalyst supporting step in step S501, the co-continuous body is immersed in an aqueous solution of a surfactant, and the surfactant is attached to the surface of the co-continuous body.

Next, in a second catalyst supporting step in step S502, the metal salt is attached to the surface of the co-continuous body to which the surfactant is attached with the surfactant using the aqueous solution of the metal salt.

Next, in a third catalyst supporting step in step S503, the catalyst made of the metal (or metal oxide) constituting the metal salt is supported on the co-continuous body by heat treatment on the co-continuous body to which the metal salt is attached.

The metal is a metal oxide made of at least one metal of iron, manganese, zinc, copper, and molybdenum, or at least one metal of calcium, iron, manganese, zinc, copper, and molybdenum. In particular, manganese (Mn) or manganese oxide (MnO₂) is preferable.

The surfactant used in the first catalyst supporting step of Manufacturing Method 5 is for supporting a metal or a transition metal oxide in high dispersion on an air electrode (co-continuous body). When a hydrophobic group adsorbed on a carbon surface and a hydrophilic group adsorbed by a transition metal ion are contained in a molecule like a surfactant, a metal ion as a transition metal oxide precursor can be adsorbed to a co-continuous body with a high degree of dispersion.

The surfactant described above is not particularly limited as long as a hydrophobic group adsorbed on the carbon surface and a hydrophilic group adsorbed by a manganese ion are contained in the molecule, but a nonionic surfactant is preferable. Examples of an ester type surfactant include glyceryl laurate, glyceryl monostearate, sorbitan fatty acid ester, and sucrose fatty acid ester. Examples of an ether type surfactant include polyoxyethylene alkyl ether, polyoxyethylene alkylphenyl ether, and polyoxyethylene polyoxypropylene glycol.

Examples of an ester ether type surfactant include polyoxyethylene sorbitan fatty acid ester, polyoxyethylene hexitane fatty acid ester, and sorbitan fatty acid ester polyethylene glycol. Examples of an alkanolamide type surfactant include laramide and cocamide DEA. Examples of a higher alcohol surfactant include cetanol, stearyl alcohol, and oleyl alcohol. Examples of a poloxamer type surfactant include poloxamer dimethacrylate.

The concentration of the aqueous solution of the surfactant in the first catalyst supporting step of Manufacturing Method 5 is preferably 0.1 to 20 g/L. Immersion conditions such as immersion time and immersion temperature include, for example, immersion in a solution of room temperature to 50° C. for 1 to 48 hours.

The second catalyst supporting step of Manufacturing Method 5 includes further dissolving a metal salt functioning as a catalyst or adding an aqueous solution of the metal salt to the aqueous solution containing a surfactant in the first catalyst supporting step. Alternatively, separately from the aqueous solution containing the surfactant, an aqueous solution in which a metal salt functioning as a catalyst is dissolved may be prepared, and the co-continuous body impregnated with (attached to) the surfactant may be immersed in the aqueous solution.

In addition, the co-continuous body to which the surfactant is attached may be impregnated with the aqueous solution in which the metal salt is dissolved. If necessary, an alkaline aqueous solution may be added dropwise to the resulting co-continuous body containing (attached to) the metal salt. As a result, the metal or metal oxide precursor can be attached to the co-continuous body.

The amount of the metal salt added in the second catalyst supporting step of Manufacturing Method 5 is preferably an amount to be 0.1 to 100 mmol/L. Immersion conditions such as immersion time and immersion temperature include, for example, immersion in a solution of room temperature to 50° C. for 1 to 48 hours.

More specifically, taking manganese as an example of the metal, a manganese metal salt (for example, manganese halides such as manganese chloride, hydrates thereof, and the like) is added to an aqueous solution containing a surfactant and impregnating the co-continuous body. Subsequently, an alkaline aqueous solution is added dropwise to the obtained co-continuous body containing a manganese metal salt, whereby manganese hydroxide as a metal or a metal oxide precursor can be supported on the co-continuous body.

The supported amount of the catalyst by manganese oxide described above can be adjusted by the concentration of the metal salt (for example, manganese chloride) in the metal salt aqueous solution.

Examples of the alkali used in the alkaline aqueous solution include a hydroxide of an alkali metal or an alkaline earth metal, ammonia water, an ammonium aqueous solution, and a tetramethylammonium hydroxide (TMAH) aqueous solution. The concentration of these alkaline aqueous solutions is preferably 0.1 to 10 mol/L.

In the third catalyst supporting step in Manufacturing Method a precursor (metal salt) of the metal or the metal oxide attached to the surface of the co-continuous body is converted into the metal itself or the metal oxide by heat treatment.

Specifically, the co-continuous body to which the precursor is attached may be dried at room temperature (about 25° C.) to 150° C., more preferably 50° C. to 100° C. for 1 to 24 hours, and then heat-treated at 100 to 600° C., preferably 110 to 300° C.

In the third catalyst supporting step in Manufacturing Method heat treatment is performed in an inert atmosphere such as argon, helium, or nitrogen or a reducing atmosphere, whereby an air electrode by a co-continuous body in which a metal itself is attached to the surface as a catalyst can be manufactured. In addition, by performing heat treatment in a gas containing oxygen (oxidizing atmosphere), it is possible to manufacture an air electrode by a co-continuous body in which a metal oxide is attached to the surface as a catalyst.

In addition, it is also possible to manufacture an air electrode by a co-continuous body to which a metal oxide is attached as a catalyst by performing a heat treatment under the above-described reduction conditions to once produce a co-continuous body to which a metal itself is attached as a catalyst and then subjecting the co-continuous body to a heat treatment in an oxidizing atmosphere.

Alternatively, a co-continuous body to which a precursor (metal salt) of a metal or a metal oxide is attached may be dried at room temperature to 150° C., more preferably 50° C. to 100° C., and the metal itself may be attached as a catalyst onto the co-continuous body to produce a metal/co-continuous body composite.

In Manufacturing Method 5, the adhesion amount (content) of the catalyst with the metal or metal oxide is 0.1 to 70 weight %, preferably 1 to 30 weight %, on the basis of the total weight of the co-continuous body and the catalyst.

According to Manufacturing Method 5, it is possible to manufacture an air electrode in which a catalyst made of a metal or a metal oxide is highly dispersed on the surface of a co-continuous body, and it is possible to form a metal-air battery having excellent electrical characteristics.

Manufacturing Method 6 (Method for Supporting Catalyst on Air Electrode)

Next, Manufacturing Method 6, which is a method for supporting a catalyst on an air electrode, will be described. In Manufacturing Method 6, a catalyst is supported on the co-continuous body produced by Manufacturing Method 2 or Manufacturing Method 3 by a method different from Manufacturing Method 5 described above. In Manufacturing Method 6, a catalyst supporting step of supporting a catalyst is added to the co-continuous body described above.

In the first catalyst supporting step, the co-continuous body is immersed in an aqueous solution of a metal salt to attach the metal salt to the surface of the co-continuous body.

Next, in the second catalyst supporting step, the catalyst made of the metal constituting the metal salt is supported on the co-continuous body by heat treatment on the co-continuous body to which the metal salt is attached.

Next, in the third catalyst supporting step, the co-continuous body on which the catalyst is supported is caused to act on high-temperature and high-pressure water to make the catalyst a hydrate of the metal oxide.

The metal (or metal oxide) constituting the metal salt is a metal oxide made of at least one metal of iron, manganese, zinc, copper, and molybdenum, or at least one metal of calcium, iron, manganese, zinc, copper, and molybdenum. In particular, manganese (Mn) or manganese oxide (MnO₂) is preferable.

In the first catalyst supporting step in Manufacturing Method 6, an aqueous solution of a metal salt to be a precursor of a metal or a metal oxide to be finally used as a catalyst is attached (supported) to the surface of the co-continuous body. For example, an aqueous solution in which the metal salt is dissolved may be separately prepared, and the co-continuous body may be impregnated with the aqueous solution. The impregnation conditions and the like are the same as those in the related art as described above.

The second catalyst supporting step in Manufacturing Method 6 is the same as the third catalyst supporting step in Manufacturing Method 5, and heat treatment in an inert atmosphere or a reducing atmosphere may be performed. Further, the co-continuous body to which the precursor is attached described as another method of the third catalyst supporting step of Manufacturing Method 5 may be heat-treated (dried) at a low temperature (room temperature to 150° C., more preferably 50° C. to 100° C.) to attach a metal to the co-continuous body.

The air electrode 101 using the metal itself as a catalyst exhibits high activity, but since the catalyst is a metal, it is weak against corrosion and lacks long-term stability in some cases. On the other hand, when the metal is heat-treated to form a hydrate of the metal oxide by the third catalyst supporting step of Manufacturing Method 6 described in detail below, long-term stability can be realized.

In the third catalyst supporting step of Manufacturing Method 6, a hydrate of the metal oxide is attached to the co-continuous body. Specifically, the co-continuous body to which the metal is attached, which is obtained in the second catalyst supporting step of Manufacturing Method 6, is immersed in high-temperature and high-pressure water, and the attached metal is converted into a catalyst made of a hydrate of a metal oxide.

For example, the co-continuous body to which the metal is attached may be immersed in water at 100° C. to 250° C., more preferably 150° C. to 200° C., and the attached metal may be oxidized to obtain a hydrate of the metal oxide.

Since the boiling point of water at atmospheric pressure (0.1 MPa) is 100° C., the co-continuous body cannot be usually immersed in water at 100° C. or higher at atmospheric pressure. However, by using a predetermined sealed container and increasing the pressure in the sealed container to, for example, 10 to 50 MPa, preferably about 25 MPa, the boiling point of water is increased in the sealed container, and liquid water at 100° C. to 250° C. can be realized. When the co-continuous body to which the metal is attached is immersed in the high-temperature water thus obtained, the metal can be made into a hydrate of the metal oxide.

Manufacturing Method 7 (Method for Supporting Catalyst on Air Electrode)

Next, Manufacturing Method 7, which is a method for supporting a catalyst on an air electrode, will be described. In Manufacturing Method 7, a catalyst is supported on the co-continuous body produced by Manufacturing Method 2 or Manufacturing Method 3 by a method different from Manufacturing Methods 5 and 6 described above. In Manufacturing Method 7, the following first catalyst supporting step and second catalyst supporting step of supporting a catalyst are added to the co-continuous body described above.

In the first catalyst supporting step, the co-continuous body is immersed in an aqueous solution of a metal salt to attach the metal salt to the surface of the co-continuous body. The first catalyst supporting step in Manufacturing Method 7 is the same as the first catalyst supporting step in Manufacturing Method 6, and the description thereof is omitted here.

Next, in the second catalyst supporting step, the precursor (metal salt) attached to the surface of the co-continuous body is converted into a hydrate of a metal oxide by heat treatment at a relatively low temperature.

Specifically, the co-continuous body to which the precursor is attached is allowed to act on high-temperature and high-pressure water, and then dried at a relatively low temperature of about 100 to 200° C. As a result, the precursor becomes a hydrate in which water molecules are present in the particles while maintaining the amorphous state of the precursor. The hydrate of the metal oxide obtained by such low-temperature drying is used as a catalyst.

The metal may be at least one metal of iron, manganese, zinc, copper, and molybdenum.

In the air electrode produced by Manufacturing Method 7, the hydrate of the metal oxide can be supported in a highly dispersed state in the form of nano-sized fine particles on the co-continuous body. Therefore, when such a co-continuous body is used as an air electrode, excellent battery performance can be exhibited.

The co-continuous body obtained by each of the above manufacturing methods can be formed into a predetermined shape by a known procedure to form an air electrode. For example, the non-catalyst-supported co-continuous body and the catalyst-supported co-continuous body may be processed into a plate-like body or a sheet, and the obtained co-continuous body may be cut into a circle having a desired diameter (for example, 23 mm) by a punching blade, a laser cutter, or the like to form an air electrode.

### EXAMPLES

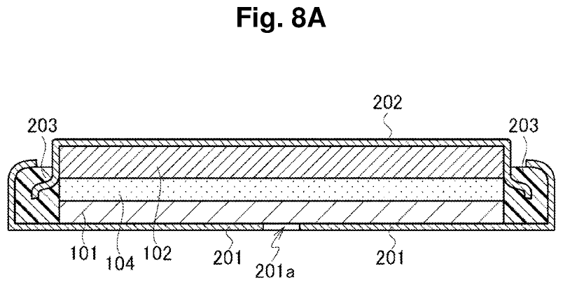

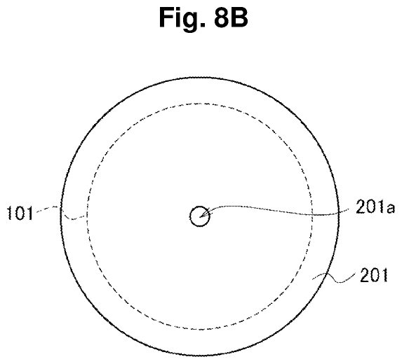

Hereinafter, the metal-air battery of the present embodiment will be described in more detail using Examples. First, a configuration of an actually used metal-air battery (see FIG. 1) will be described with reference to FIGS. 8A and 8B. FIG. 8A is a cross-sectional view illustrating a more detailed configuration example of a coin cell type metal-air battery. FIG. 8B is a plan view illustrating a configuration example of a coin cell type metal-air battery. The metal-air battery using the air electrode 101, the negative electrode 102, and the electrolytic solution 104 in the above-described embodiment can be produced in a conventional shape such as a coin shape, a cylindrical shape, or a laminate shape. As a method for manufacturing these batteries, a method similar to the conventional method can be used.

As illustrated in FIGS. 8A and 8B, the coin cell type battery includes an air electrode 101, a negative electrode 102, and an electrolytic solution 104. The electrolytic solution 104 in this case is an electrolytic solution containing an ion conductor and in which an alkyl glucoside is dissolved at a saturated concentration. An air electrode case 201 is disposed on the air electrode side, and a negative electrode case 202 is disposed on the negative electrode side. The air electrode case 201 includes an opening 201a, and surrounding air can come into contact with the air electrode 101.

The air electrode case 201 and the negative electrode case 202 are fitted to each other, and a gasket 203 is disposed at the fitted portion. An electrolytic solution 104 is sandwiched between the air electrode 101 and the negative electrode 102, and these are used as a battery cell. The battery cell is disposed between the air electrode case 201 and the negative electrode case 202, and the air electrode case 201 and the negative electrode case 202 are fitted and integrated.

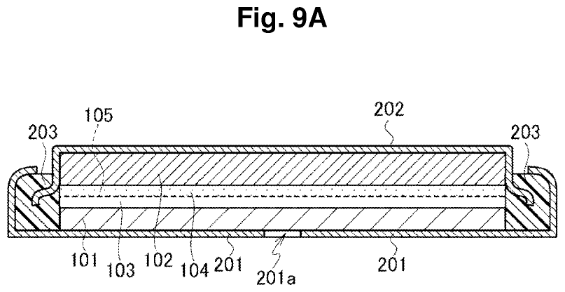

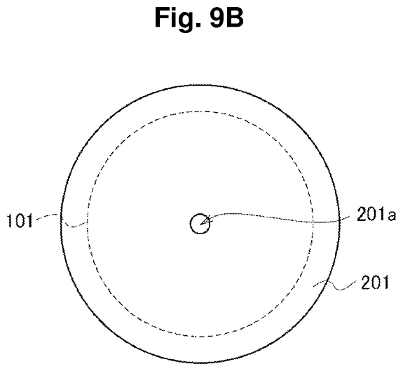

FIGS. 9A and 9B are a cross-sectional view and a plan view, respectively, illustrating a configuration example of a coin cell type metal-air battery corresponding to another metal-air battery (see FIG. 2). The illustrated metal-air battery can be produced in a conventional shape such as a coin shape, a cylindrical shape, or a laminate shape, similarly to the coin cell type battery of FIGS. 8A and 8B. As a method for manufacturing these batteries, a method similar to the conventional method can be used.

The coin cell type battery illustrated in FIGS. 9A and 9B includes an air electrode 101, a negative electrode 102, an electrolytic solution 103 on the air electrode side, an electrolytic solution 104 on the negative electrode side, and an ion exchange membrane 105. The electrolytic solutions 103 and 104 in this case are aqueous solutions containing an ion conductor, and alkyl glucosides are dissolved in the electrolytic solution 104. The electrolytic solution 103 on the air electrode side, the ion exchange membrane 105, and the electrolytic solution 104 on the negative electrode side are sandwiched between the air electrode 101 and the negative electrode 102, and these are used as a battery cell. The battery cell is disposed between the air electrode case 201 and the negative electrode case 202, and the air electrode case 201 and the negative electrode case 202 are fitted and integrated. The air electrode case 201 and the negative electrode case 202 are similar to the coin cell type battery in FIGS. 8A and 8B.

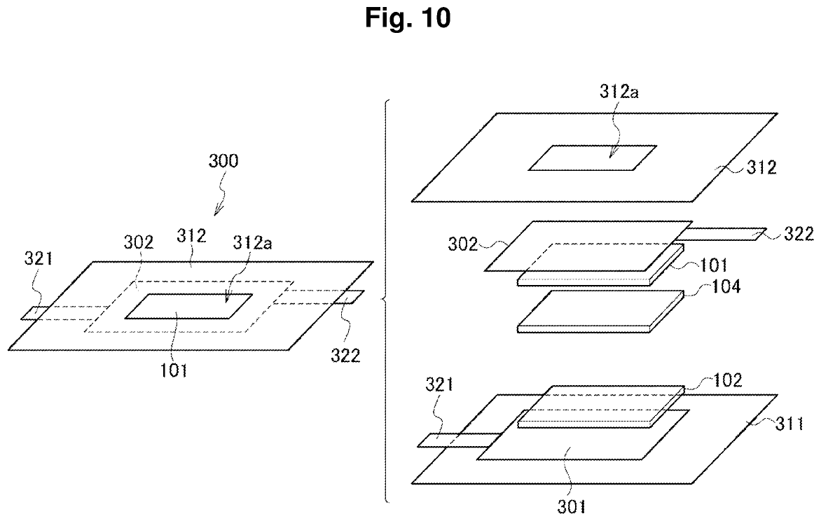

As illustrated in FIG. 10, a housing 300 that seals the inside of the battery cell other than the air electrode 101 may be used to house the battery cell in the housing 300. The housing 300 includes a first housing 311 disposed on the negative electrode 102 side and a second housing 312 disposed on the air electrode 101 side. An opening 312a is formed in the second housing 312 so that surrounding air can come into contact with the air electrode 101.

A negative electrode current collector 301 is provided between the first housing 311 and the negative electrode 102, an air electrode current collector 302 is provided between the second housing 312 and the air electrode 101, and terminals 321 and 322 are taken out of the housing 300 from the negative electrode current collector and the air electrode current collector, respectively. When a metal is used as the negative electrode 102, the terminal may be directly taken out from the negative electrode 102 to the outside without using the negative electrode current collector 301.

In addition, the housing 300 may be made of a material that can maintain the battery cell inside and is naturally decomposed. The housing 300 may be made of any material of a natural product type, a microbial type, and a chemical synthesis type, and can be made of, for example, polylactic acid, polycaprolactone, polyhydroxyalkanoate, polyglycolic acid, modified polyvinyl alcohol, casein, modified starch, or the like. In particular, a chemical synthesis type such as plant-derived polylactic acid is preferable. The shape of the housing 300 is not limited as long as it is a shape obtained by processing biodegradable plastic. Examples of the material that can be used for the housing 300 include, in addition to a commercially available biodegradable plastic film, a paper on which a coating film of a resin such as polyethylene used for a milk pack or the like is formed, and an agar film.

It is possible to seal the inside of the battery cell other than the air electrode 101 by bonding the first housing 311 and the second housing 312 made of the above-described materials at a peripheral edge portion. Examples of the bonding method include thermal sealing and use of an adhesive, and are not particularly limited. It is preferable to use an adhesive composed of a biodegradable resin. The shapes of the air electrode 101, the negative electrode 102, the electrolytic solution 104, the first housing 311, the second housing 312, the negative electrode current collector 301, and the air electrode current collector 302 are not limited as long as the arrangement thereof for operating as a battery is not impaired. For example, it can be used in a quadrangular or circular sheet shape or a rolled shape in a plan view.

When used in a disposable device such as a soil moisture sensor, for example, the metal-air battery by the housing 300 made of the above-described material to be naturally decomposed is naturally decomposed over time, and there is no need to recover the battery. In addition, since it is composed of a naturally-derived material or a fertilizer component, the load on the environment is extremely low.

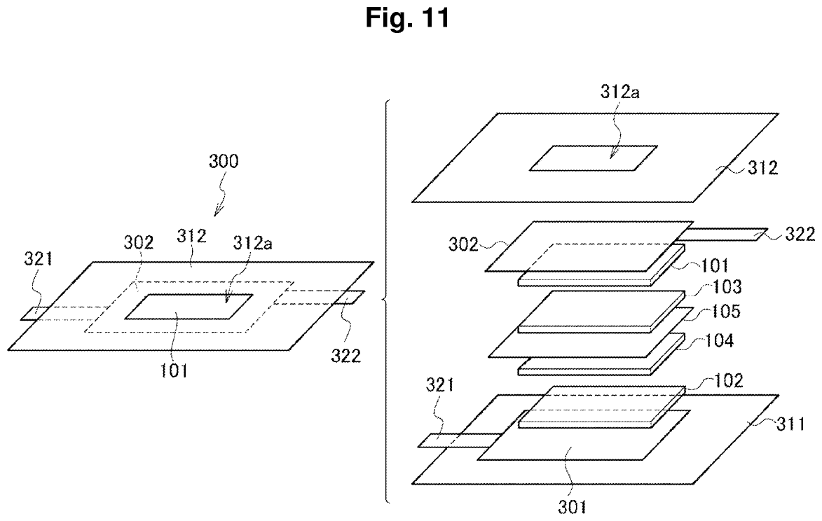

FIG. 11 is a configuration example in which the battery cell of the second metal-air battery (see FIG. 2) is housed in the housing 300.

### Example 1 (Example of Ketjen Black Air Electrode)

First, Example 1 will be described. In Example 1, carbon (Ketjen Black EC600JD) known as an electrode was used as an air electrode, and the effect of adding an alkyl glucoside having 18 to 22 carbon atoms was examined.

Ketjen black powder (manufactured by Lion Corporation) of carbon (Ketjen Black EC600JD) and polytetrafluoroethylene (PTFE) powder (manufactured by Daikin Industries, Ltd.) were sufficiently pulverized and mixed at a weight ratio of 80:20 using a roughing machine, and roll-formed to produce a sheet-shaped electrode (thickness: 0.6 mm). The sheet-shaped electrode was cut into a circle having a diameter of 14 mm to obtain an air electrode.

The negative electrode was adjusted by cutting out a commercially available magnesium alloy AZ31 plate (thickness 200 μm, manufactured by Nilaco Corporation) into a circle having a diameter of 14 mm with a punching blade, a laser cutter, or the like.

As the electrolytic solution, sodium chloride (NaCl, manufactured by KANTO CHEMICAL CO., INC.) was dissolved in pure water at a concentration of 1 mol/L. In this sodium chloride aqueous solution, three kinds of alkyl glucosides having 18, 20, and 22 carbon atoms were each dissolved in an amount of 5 mg or more per 1 mL at room temperature to prepare each alkyl glucoside aqueous solution having a saturated concentration.

The air electrode and the negative electrode described above were used to produce the coin cell type magnesium-air battery described with reference to FIGS. 8A and 8B. First, the air electrode was provided on an air electrode case in which a peripheral edge portion of a copper mesh foil (manufactured by MIT Japan) was fixed to the inside by spot welding. In the negative electrode formed of a metallic magnesium plate, a peripheral edge portion was fixed to a copper mesh foil (manufactured by MIT Japan) by spot welding, and the copper mesh foil was fixed to a negative electrode case by spot welding.

2 ml of the electrolytic solution was dropped onto an air electrode provided in an air electrode case, and then a cellulose-based separator for a battery (manufactured by Nippon Advanced Paper Industries Co., Ltd.) cut into a circle having a diameter of 14 mm was placed thereon, and 2 ml of the electrolytic solution was dropped.

In Example 1, as the electrolytic solution, an electrolytic solution in which an alkyl glucoside having 18 carbon atoms is dissolved, an electrolytic solution in which an alkyl glucoside having 20 carbon atoms is dissolved, and an electrolytic solution in which an alkyl glucoside having 22 carbon atoms is dissolved are used. Therefore, in Example 1, three types of magnesium-air batteries are produced.

Next, the air electrode case was covered with the negative electrode case to which the negative electrode was fixed, and peripheral edge portions of the air electrode case and the negative electrode case were crimped with a coin cell crimping machine to produce each of coin cell type magnesium-air batteries including a polypropylene gasket.

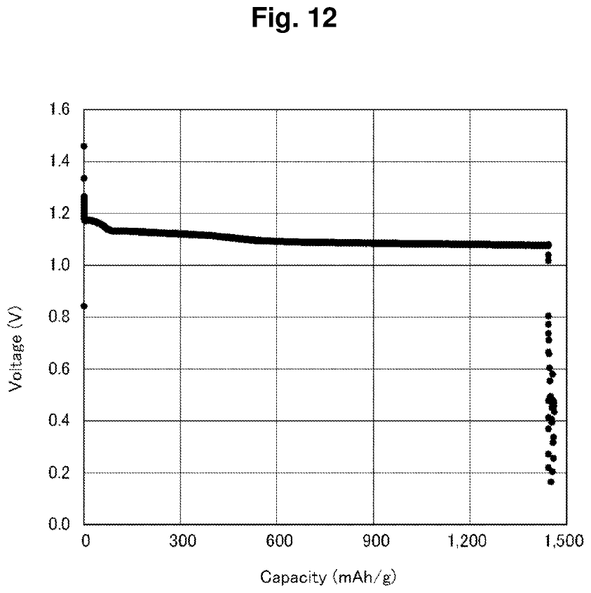

The battery performance of each produced magnesium-air battery was measured. First, a discharge test was performed. In the discharge test of the magnesium-air battery, a commercially available charge and discharge measurement system (SD8 charge/discharge system manufactured by HOKUTO DENKO CORPORATION) was used, and 0.1 mA/cm 2 was passed at a current density per effective area of the air electrode, and the measurement was performed until the battery voltage decreased from the open circuit voltage to 0 V. The discharge test was measured in a constant temperature bath at (atmosphere was under normal living environment). The discharge capacity was expressed as a value (mAh/g) per weight of the air electrode including the co-continuous body. The discharge curve in the battery of Example 1 using the alkyl glucoside having 18 carbon atoms is illustrated in FIG. 12.

As illustrated in FIG. 12, it can be seen that the average discharge voltage is 1.1 V, and the discharge capacity is 1450 mAh/g. The average discharge voltage is a battery voltage at a discharge capacity (here, 725 mAh/g) of ½ of the discharge capacity (here, 1450 mAh/g) of the battery.

Table 1 below shows the discharge capacity of a magnesium-air battery using an electrolytic solution to which each of three kinds of alkyl glucosides is added.

TABLE 1

| Carbon number | Discharge capacity (mAh/g) |
|---|---|
| 18 | 1450 |
| 20 | 1430 |
| 22 | 1410 |

The discharge capacities of Example 1 were all 1400 mAh/g or more, which were larger than those of Comparative Example 1 described later. This is considered to be because the electrolytic solution containing alkyl glucoside as a surfactant suppressed the corrosion reaction of the negative electrode, and the reaction time was lengthened, resulting in an increase in the discharge capacity. It is considered that the alkyl glucoside having 18 to 22 carbon atoms is more effective in suppressing corrosion than the alkyl glucoside having 16 carbon atoms and Triton-X100 used in Comparative Example 1.

The HLB values indicating the magnitude of hydrophilicity are 16 and 13.5 for the alkyl glucoside having 16 carbon atoms and Triton-X100, respectively. The HLB values of the alkyl glucosides having 18, 20, and 22 carbon atoms are 9, 7, and 5, respectively, and are smaller than the HLB values of the alkyl glucoside having 16 carbon atoms and Triton-X100. Therefore, it can be said that the alkyl glucoside having 18 to 22 carbon atoms has a higher lipophilicity than the alkyl glucoside having 16 carbon atoms and Triton-X100.

Since the larger the lipophilicity, the larger the adsorption power to the metal surface, and the negative electrode surface can be covered with a larger covering area, it is considered that in Example 1 using the alkyl glucoside having 18 to 22 carbon atoms, the corrosion suppressing effect was increased. In this way, the discharge capacity was improved by the effect of suppressing corrosion in the alkyl glucoside having any carbon number in Example 1. Therefore, by adding the alkyl glucoside having 18 to 22 carbon atoms to the electrolytic solution, corrosion of the negative electrode can be suppressed, and the discharge capacity can be improved.

The greater the lipophilicity, the smaller the solubility in water. When the solubility in water is small, the number of molecules in the aqueous solution decreases, and there is also an influence that the covering area decreases. The reason why the largest discharge capacity was exhibited when an alkyl glucoside having 18 carbon atoms was added among the carbon atoms shown in Table 1 is considered to be that the balance between the solubility in water and the adsorption power to the surface of the negative electrode was optimal when the number of carbon chains was 18.

On the other hand, the voltages (average discharge voltages) of Example 1 were all lower than the voltage (1.3 V) when a sodium chloride aqueous solution was used as the electrolytic solution of Comparative Example 1. It is considered that since the alkyl glucoside hydrophilized the air electrode, the air electrode was easily submerged, and thus the voltage of Example 1 was lowered.

### Example 2 (Example of Air Electrode of Nanosheet Co-Continuous Body)

Next, Example 2 will be described. Example 2 is an example in which a co-continuous body using nanosheets is used as an air electrode. The discontinuous body has a three-dimensional network structure composed of a plurality of nanosheets integrated by non-covalent bonds.

An air electrode was synthesized as follows. In the following description, as a representative, a manufacturing method using graphene as a nanosheet will be shown, but by changing graphene to nanosheets of another material, a co-continuous body having a three-dimensional network structure can be adjusted. The porosities shown below were calculated by modeling the pores as cylindrical from the pore diameter distribution of the co-continuous body obtained by the mercury intrusion method. The production of a magnesium-air battery and the method of a discharge test were performed in the same manner as in Example 1.

First, a commercially available graphene sol [dispersion medium: water (H₂O), 0.4 weight %, silicon “manufactured by Sigma-Aldrich Co. LLC.” was placed in a test tube, and the test tube was immersed in liquid nitrogen for 30 minutes to completely freeze the graphene sol. After completely freezing the graphene sol, the frozen graphene sol was taken out into an eggplant flask and dried in a vacuum of 10 Pa or less by a freeze dryer (manufactured by TOKYO RIKAKIKAI CO., LTD.) to obtain a stretchable co-continuous body having a three-dimensional network structure including graphene nanosheets.

The obtained co-continuous body was evaluated by performing X-ray diffraction (XRD) measurement, scanning electron microscope (SEM) observation, porosity measurement, a tensile test, and BET specific surface area measurement. The co-continuous body produced in the present example was confirmed to be a carbon (C, PDF card No. 01-075-0444) single phase by XRD measurement. Note that the PDF card No. is a card number of a powder diffraction file (PDF) which is a database collected by the International Centre for Diffraction Data (ICDD), and the same applies hereinafter.

In addition, it was confirmed by SEM observation and a mercury intrusion method that the obtained co-continuous body was a co-continuous body in which nanosheets (graphene pieces) were continuously connected and which had an average pore size of 1 μm. In addition, the BET specific surface area of the co-continuous body was measured by a mercury intrusion method and found to be 510 m²/g. In addition, the porosity of the co-continuous body was measured by a mercury intrusion method and found to be 90% or more. Furthermore, from the results of the tensile test, it was confirmed that the obtained co-continuous body did not exceed the elastic region and restored to the shape before stress application even when 20% of strain was applied by tensile stress.

Such a co-continuous body made of graphene was cut into a circle having a diameter of 14 mm with a punching blade, a laser cutter, or the like to obtain a gas diffusion type air electrode.

The negative electrode was adjusted by cutting out a commercially available magnesium alloy AZ31 plate (thickness 200 μm, manufactured by Nilaco Corporation) into a circle having a diameter of 14 mm with a punching blade, a laser cutter, or the like.

As the electrolytic solution, an alkyl glucoside having 18 carbon atoms was used. Specifically, sodium chloride (NaCl, manufactured by KANTO CHEMICAL CO., INC.) was dissolved in pure water at a concentration of 1 mol/L, and an alkyl glucoside aqueous solution obtained by adding 5 mg or more of an alkyl glucoside having 18 carbon atoms per 1 mL of the sodium chloride aqueous solution to have a saturated concentration was used as an electrolytic solution.

The battery performance of a coin cell type air battery was produced in the same manner as in Example 1, and the battery performance was evaluated.

Table 2 below shows the discharge capacity of a magnesium-air battery in which a co-continuous body is formed from nanosheets made of graphene (C), iron oxide (Fe₂O₃), manganese oxide (MnO₂), zinc oxide (ZnO), molybdenum oxide (MoO₃), and molybdenum sulfide (MoS₂) and used as an air electrode.

TABLE 2

| Nanosheet material | Discharge capacity (mAh/g) |
|---|---|
| Graphene (C) | 1540 |
| Iron oxide (Fe₂O₃) | 1520 |
| Manganese oxide (MnO₂) | 1570 |
| Zinc oxide (ZnO) | 1530 |
| Molybdenum oxide (MoO₃) | 1470 |
| Molybdenum sulfide (MoS₂) | 1470 |

In the graphene of Example 2, the discharge capacity was 1540 mAh/g, which was larger than that in the case of using the air electrode made of commercially available carbon (Ketjen Black EC600JD) of Example 1. The discharge capacities of Example 2 were all larger than 1450 mAh/g, which were larger than that of Example 1 using Ketjen black.

Also in the case of an example of nanosheets made of a material other than carbon, it is considered that since the nanosheets had a high specific surface area like graphene, the discharge product [Mg(OH)₂] was efficiently precipitated, and thus the discharge capacity was improved.

Even when the nanosheet co-continuous body was used as an air electrode, the effect of improving the discharge capacity by adding an alkyl glucoside having 18 to 22 carbon atoms was confirmed. Based on the evaluation result of Example 1, it can be said that the discharge capacity is also improved for the alkyl glucoside having a carbon number other than 18.

### Example 3 (Example of Air Electrode of Nanosheet Co-Continuous Body)

Next, Example 3 will be described. Example 3 is an example in which a co-continuous body using nanofibers is used as an air electrode. The co-continuous body has a three-dimensional network structure composed of a plurality of nanofibers integrated by non-covalent bonds.

An air electrode was synthesized as follows. In the following description, as a representative, a manufacturing method using carbon nanofibers will be shown, but by changing the carbon nanofibers to nanofibers made of other materials, a co-continuous body having a three-dimensional network structure can be adjusted.

The evaluation method of a co-continuous body, the production of a magnesium-air battery, and the method of a discharge test were performed in the same manner as in Examples 1 and 2.

A co-continuous body was produced in the same manner as in the process shown in Example 2, and carbon nanofiber sol [dispersion medium: water (H₂O), 0.4 weight %, manufactured by Sigma-Aldrich Co. LLC.] was used as a raw material.

The obtained co-continuous body was evaluated by performing XRD measurement, SEM observation, porosity measurement, a tensile test, and BET specific surface area measurement. The co-continuous body produced in the present example was confirmed to be a carbon (C, PDF card No. 00-058-1638) single phase by XRD measurement. In addition, it was confirmed by SEM observation and a mercury intrusion method that the obtained co-continuous body was a co-continuous body in which nanofibers were continuously connected and which had an average pore size of 1 μm. In addition, the BET specific surface area of the co-continuous body was measured by a mercury intrusion method and found to be 620 m²/g. In addition, the porosity of the co-continuous body was measured by a mercury intrusion method and found to be 93% or more. Furthermore, from the results of the tensile test, it was confirmed that the co-continuous body of Example 3 did not exceed the elastic region and restored to the shape before stress application even when 40% of strain was applied by tensile stress.

A coin cell type magnesium-air battery similar to that of Example 2 was produced using the co-continuous body made of carbon nanofibers as an air electrode. As the electrolytic solution of Example 3, an alkyl glucoside having 18 carbon atoms was used in the same manner as in Example 2. The discharge capacity of the produced magnesium-air battery in Example 3 is shown in Table 3.

TABLE 3

| Nanosheet material | Discharge capacity (mAh/g) |
|---|---|
| Carbon nanofibers (C) | 1570 |
| Iron oxide (Fe₂O₃) | 1550 |
| Manganese oxide (MnO₂) | 1600 |
| Zinc oxide (ZnO) | 1560 |
| Molybdenum oxide (MoO₃) | 1500 |
| Molybdenum sulfide (MoS₂) | 1500 |

In the carbon nanofibers (C) of Example 3, the discharge capacity was 1570 mAh/g, which was larger than that in the case of using the co-continuous body made of graphene of Example 2. The improvement of such characteristics is considered to be due to smooth reaction at the time of discharge by using a co-continuous body having higher stretchability.

Table 3 shows the discharge capacity of a magnesium-air battery in which a co-continuous body is formed from nanofibers made of carbon nanofibers (C), iron oxide (Fe₂O₃), manganese oxide (MnO₂), zinc oxide (ZnO), molybdenum oxide (MoO₃), and molybdenum sulfide (MoS₂) and used as an air electrode.

In all cases, the discharge capacity was 1500 mAh/g or more, which was a larger value as a whole than that of the co-continuous body including the nanosheets as in Example 2. Also in the case of these nanofibers, similarly to the nanosheets, it is considered that the discharge capacity was improved because the air electrode having stretchability efficiently precipitated the discharge product [mg(OH)₂].

Even when the co-continuous body made of nanofibers was used as an air electrode, the effect of improving the discharge capacity by adding an alkyl glucoside having 18 to 22 carbon atoms was confirmed.

### Example 4 (Example of Air Electrode of Bacteria Produced Cellulose Co-Continuous Body)

Next, Example 4 will be described. Example 4 is an example in which a co-continuous body made of a gel in which cellulose produced by bacteria is dispersed is used as the air electrode. The evaluation method of a co-continuous body, the production method of a magnesium-air battery, and the method of a discharge test were performed in the same manner as in Examples 1, 2, and 3.

First, a coin cell type magnesium-air battery similar to that of Examples 1 and 2 was produced using Nata Decoco (manufactured by Fujico Corporation) as a bacterium cellulose gel produced by Acetobacter xylinum as an acetic acid bacterium. In Example 4, the co-continuous body was carbonized by drying in vacuum and then calcining at 1200° C. for 2 hours in a nitrogen atmosphere, thereby producing an air electrode.

The obtained co-continuous body (carbonized co-continuous body) was evaluated by performing XRD measurement, SEM observation, porosity measurement, a tensile test, and BET specific surface area measurement. This co-continuous body was confirmed to be a carbon (C, PDF card No. 01-071-4630) single phase by XRD measurement. In addition, it was confirmed by SEM observation that the co-continuous body was a co-continuous body in which nanofibers having a diameter of 20 nm were continuously connected. In addition, the BET specific surface area of the co-continuous body was measured by a mercury intrusion method and found to be 830 m²/g. In addition, the porosity of the co-continuous body was measured by a mercury intrusion method and found to be 99% or more. Furthermore, from the results of the tensile test, it was confirmed that the elastic region was not exceeded and the shape was restored to the shape before stress application even when 80% of strain was applied by tensile stress, and excellent stretchability was exhibited even after carbonization.

A coin cell type magnesium-air battery similar to that of Example 2 was produced using the co-continuous body made of bacteria produced cellulose as an air electrode. As the electrolytic solution of Example 4, an alkyl glucoside having 18 carbon atoms was used in the same manner as in Example 2.

The discharge capacity of the magnesium-air battery in Example 4 is shown in Table 4 below. Table 4 also shows the results of Example 1 to 3 using an alkyl glucoside having 18 carbon atoms. In Example 4, the discharge capacity was 1970 mAh/g, and the performance was improved as compared with Examples 1 to 3.

TABLE 4

| | Average | Discharge |
|---|---|---|
| | discharge | capacity |
| Examples | voltage (V) | (mAh /g) |
| Example 1 | 1.1 | 1450 |
| (Ketjen Black) | | |
| Example 2 | 1.0 | 1540 |
| (Graphene) | | |
| Example 3 | 1.0 | 1570 |
| (Carbon nanofibers) | | |
| Example 4 | 1.1 | 1970 |
| (Carbonized bacterial | | |
| cellulose) | | |

Regarding the improvement of the characteristics as described above, it is considered that the discharge product [Mg(OH)₂] was efficiently precipitated at the time of discharge by using a co-continuous body having higher stretchability, and the reaction was smoothly performed because the carbon (C) had excellent conductivity.

As described above, according to the present example, a co-continuous body having high porosity and stretchability is obtained by BET specific surface area measurement, and according to the magnesium-air battery using the co-continuous body as an air electrode, efficient precipitation of a discharge product [Mg(OH)₂] at the time of discharge is realized. The improvement of the characteristics as described above is considered to be due to various improvements according to the present embodiment.

Even when a co-continuous body made of carbonized bacterial cellulose was used as an air electrode, the effect of improving the discharge capacity by adding an alkyl glucoside having 18 to 22 carbon atoms was confirmed.

### Example 5 (Example in Which Metal Species of Negative Electrode is Changed in Ketjen Black Air Electrode)

In Example 5, carbon (Ketjen Black EC600JD) known as an electrode for an air electrode was used, and the metal species used for the negative electrode was changed. The production method of a battery of Example 5 and the method of a discharge test were performed in the same manner as in Example 1. As the electrolytic solution of Example 5, an alkyl glucoside having 18 carbon atoms was used.

In Example 5, a plurality of metal-air batteries were produced using a magnesium alloy AZ31 plate (thickness 200 μm, manufactured by Nilaco Corporation), an aluminum plate (thickness: 200 μm, Nilaco Corporation), a zinc plate (thickness: 200 μm, Nilaco Corporation), and an iron plate (thickness: 200 μm, Nilaco Corporation) as negative electrodes.

Table 5 below shows the discharge capacity of the metal-air battery of Example 5. Table 5 also shows the results of Example 1 using an alkyl glucoside having 18 carbon atoms.

TABLE 5

| | | Average | Discharge |
|---|---|---|---|
| | Negative | discharge | capacity |
| | electrode | voltage (V) | (mAh/g) |
| Example 1 | Magnesium | 1.1 | 1450 |
| | alloy (AZ31) | | |
| Example 5 | Magnesium | 1.1 | 1160 |
| | alloy (AZX) | | |
| Example 5 | Aluminum | 1.0 | 1110 |
| Example 5 | Zinc | 0.9 | 1000 |
| Example 5 | Iron | 0.8 | 970 |

The difference in characteristics as described above is considered to be affected by the ease of dissolution in the electrolytic solution due to the ionization tendency of the metal. Specifically, it is considered that when a magnesium alloy AZ31 plate was used for the negative electrode (Example 1), electrons generated along with dissolution of the negative electrode metal were most efficiently used for the battery reaction.

The discharge capacity in the case of using zinc in the negative electrode of Example 5 was larger than that of Comparative Example 3 to be described later in which an alkyl glucoside was not added.

According to the present example, by using the magnesium alloy AZ31 plate for the negative electrode of the metal-air battery, the most efficient electron flow is realized at the time of discharge, but even when other metals or alloys are used, an effect of improving the discharge capacity by adding an alkyl glucoside was observed.

### Example 6 (Example Using Ion Exchange Membrane)

Example 6 is an example of a metal-air battery in which an ion exchange membrane is disposed between a negative electrode and an air electrode, and an electrolytic solution on the negative electrode side and an electrolytic solution on the air electrode side are separated by the ion exchange membrane. In the present example, the coin cell type magnesium-air battery described in FIGS. 9A and 9B was produced.

Specifically, an electrolytic solution obtained by dissolving sodium chloride in pure water at a concentration of 1 mol/L was used as an electrolytic solution a on the air electrode side. An electrolytic solution obtained by adding an alkyl glucoside having 18 carbon atoms to the electrolytic solution a on the air electrode side until saturation was used as an electrolytic solution b on the negative electrode side. The electrolytic solution a was disposed on the air electrode side, the electrolytic solution b was disposed on the negative electrode side, and an ion exchange membrane was disposed therebetween. A neoceptor was used for the ion exchange membrane. Carbon (Ketjen Black EC600JD) and a magnesium alloy AZ31 similar to those in Example 1 were used for the air electrode and the negative electrode, respectively. The method of the discharge test is the same as that in Example 1.

Table 6 below shows the discharge capacity of the metal-air battery of Example 6. Table 6 also shows the results of Example 1 (alkyl glucoside having 18 carbon atoms) in which the ion exchange membrane 105 is not used.

TABLE 6

| | Ion | Average | Discharge |
|---|---|---|---|
| | exchange | discharge | capacity |
| | membrane | voltage (V) | (mAh/g) |
| Example 1 | None | 1.1 | 1450 |
| Example 6 | Neoceptor | 1.3 | 1630 |

The discharge capacity of Example 6 was 1630 mAh/g, and the voltage was 1.3 V, which were larger than those in the case where the ion exchange membrane of Example 1 was not used. It is considered that since the electrolytic solution b containing the alkyl glucoside suppresses the corrosion reaction of the negative electrode, the reaction time becomes long, and the alkyl glucoside does not reach the air electrode due to the ion exchange membrane, so that the air electrode is prevented from being hydrophilized and submerged, oxygen supply becomes possible for a long time, and the voltage and the discharge capacity are improved.

Specifically, the ion exchange membrane allows permeation of only hydroxide ions, and suppresses diffusion (movement) of alkyl glucoside contained in the electrolyte b into the electrolytic solution a on the air electrode side. In the present example, an alkyl glucoside is added only to the electrolytic solution b on the negative electrode side, and an ion exchange membrane that suppresses diffusion of the surfactant between the electrolytic solution b and the electrolytic solution a on the air electrode side is provided. Thereby, in the present example, it is possible to prevent the alkyl glucoside from diffusing into the electrolytic solution a on the air electrode side, hydrophilizing the air electrode, submerging the air electrode in the electrolyte a, and lowering the battery voltage.

### Comparative Example 1

Next, Comparative Example 1 will be described. In Comparative Example 1, a plurality of magnesium-air batteries were produced in the same manner as in Experimental Example 1 using the respective electrolytic solutions shown in Table 7. Carbon (Ketjen Black EC600JD) and a magnesium alloy AZ31 similar to those in Example 1 were used for the air electrode and the negative electrode in Comparative Example 1, respectively.

As the electrolytic solution of Comparative Example 1, a 1 mol/L sodium chloride aqueous solution, an aqueous solution obtained by adding 5 mg or more of Triton-X100 (nonionic surfactant) per 1 mL to a 1 mol/L sodium chloride aqueous solution to have a saturated concentration, an aqueous solution obtained by adding 5 mg or more of an alkyl glucoside having 16 carbon atoms per 1 mL to a 1 mol/L sodium chloride aqueous solution to have a saturated concentration, and an aqueous solution obtained by adding 5 mg or more of an alkyl glucoside having 24 carbon atoms per 1 mL to a 1 mol/L sodium chloride aqueous solution to have a saturated concentration were used, respectively.

The alkyl glucoside having 24 carbon atoms was hardly dissolved in an aqueous sodium chloride solution, and was saturated at a concentration of less than 1×10⁻⁶ mol/L.

The method of the discharge test is the same as that in Example 1. Table 7 below shows the discharge capacity of the metal-air battery of Comparative Example 1. Table 7 also shows the results of Example 1 (alkyl glucoside having 18 carbon atoms).

TABLE 7

| | | Average | Discharge |
|---|---|---|---|
| | | discharge | capacity |
| | | voltage (V) | (mAh/g) |
| Example 1 | Alkyl glucoside | 1.1 | 1450 |
| | (18 carbon atoms) | | |
| | aqueous solution | | |
| Comparative | Sodium chloride | 1.3 | 1030 |
| Example 1 | aqueous solution | | |
| Comparative | Triton-X100 | 1.1 | 1210 |
| Example 1 | aqueous solution | | |
| Comparative | Alkyl glucoside | 1.1 | 1320 |
| Example 1 | (16 carbon atoms) | | |
| | aqueous solution | | |
| Comparative | Alkyl glucoside | 1.2 | 1050 |
| Example 1 | (24 carbon atoms) | | |
| | aqueous solution | | |

The battery using the sodium chloride aqueous solution as an electrolytic solution had a voltage of 1.3 V and a discharge capacity of 1030 mAh/g. The battery using the electrolytic solution to which Triton-X100 was added had a voltage of 1.1 V and a discharge capacity of 1210 mAh/g. The battery of an electrolytic solution to which the alkyl glucoside having 16 carbon atoms was added had a voltage of 1.1 V and a discharge capacity of 1320 mAh/g. The battery of an electrolytic solution to which the alkyl glucoside having 24 carbon atoms was added had a voltage of 1.2 V and a discharge capacity of 1050 mAh/g. In all the comparative examples, the discharge capacities were smaller than those in Example 1.

From the above results, it was confirmed that the metal-air battery of the present embodiment was superior in discharge capacity to a metal-air battery in which an alkyl glucoside was not added. In addition, it was also confirmed that the metal-air battery of the present embodiment in which the alkyl glucoside having 18 to 22 carbon atoms was added had an improved discharge capacity as compared with a metal-air battery in which Triton-X100 as a nonionic surfactant and alkyl glucosides having 16 and 24 carbon atoms were added.

It is considered that the HLB value of the alkyl glucoside having 24 carbon atoms was 3, and the alkyl glucoside was hardly dissolved in a sodium chloride aqueous solution because of its low hydrophilicity, so that no corrosion suppressing effect was observed.

### Comparative Example 2

Next, Comparative Example 2 will be described. In Comparative Example 2, a plurality of magnesium-air batteries similar to those in Example 4 were produced using a co-continuous body made of a gel in which cellulose produced by bacteria was dispersed as an electrode for an air electrode, and using the following electrolytic solutions. As a negative electrode, a magnesium alloy AZ31 was used. As the electrolytic solution, an alkyl glucoside having 18 carbon atoms was used.

As the electrolytic solution of Comparative Example 2, a 1 mol/L sodium chloride aqueous solution, an aqueous solution obtained by adding 5 mg or more of Triton-X100 per 1 mL to a 1 mol/L sodium chloride aqueous solution to have a saturated concentration, and an aqueous solution obtained by adding 5 mg or more of an alkyl glucoside having 16 carbon atoms per 1 mL to a 1 mol/L sodium chloride aqueous solution to have a saturated concentration were used, respectively.

The method of the discharge test is the same as that in Example 1. Table 8 below shows the discharge capacity of the metal-air battery of Comparative Example 2. Table 8 also shows the results of Example 4.

TABLE 8

| | | Average | Discharge |
|---|---|---|---|
| | | discharge | capacity |
| | | voltage (V) | (mAh/g) |
| Example 4 | Alkyl glucoside | 1.1 | 1970 |
| | (18 carbon atoms) | | |
| | aqueous solution | | |
| Comparative | Sodium chloride | 1.3 | 1450 |
| Example 2 | aqueous solution | | |
| Comparative | Triton-X100 | 1.1 | 1700 |
| Example 2 | aqueous solution | | |
| Comparative | Alkyl glucoside | 1.1 | 1800 |
| Example 2 | (16 carbon atoms) | | |
| | aqueous solution | | |

The battery using the sodium chloride aqueous solution as an electrolytic solution had a voltage of 1.3 V and a discharge capacity of 1450 mAh/g. The battery using the electrolytic solution to which Triton-X100 was added had a voltage of 1.1 V and a discharge capacity of 1700 mAh/g. The battery of an electrolytic solution to which the alkyl glucoside having 16 carbon atoms was added had a voltage of 1.1 V and a discharge capacity of 1800 mAh/g. In all the comparative examples, the discharge capacities were smaller than those in Example 4.

From the above results, it was confirmed that the metal-air battery of the present embodiment was superior in discharge capacity to a metal-air battery in which an alkyl glucoside having 18 to 22 carbon atoms was not added even when a co-continuous body made of a gel in which cellulose produced by bacteria was dispersed was used as an electrode for an air electrode.

### Comparative Example 3

Next, Comparative Example 3 will be described. In Comparative Example 3, a zinc-air battery cell similar to that in Example 5 was produced using the following electrolytic solutions. Carbon (Ketjen Black EC600JD) was used for the air electrode, and zinc was used for the negative electrode. As the electrolytic solution, an alkyl glucoside having 18 carbon atoms was used.

As the electrolytic solution of Comparative Example 3, a 1 mol/L sodium chloride aqueous solution, an aqueous solution obtained by adding 5 mg or more of Triton-X100 per 1 mL to a 1 mol/L sodium chloride aqueous solution to have a saturated concentration, and an aqueous solution obtained by adding 5 mg or more of an alkyl glucoside having 16 carbon atoms per 1 mL to a 1 mol/L sodium chloride aqueous solution to have a saturated concentration were used, respectively.

The method of the discharge test is the same as that in Example 1. Table 9 below shows the discharge capacity of the metal-air battery of Comparative Example 3. Table 9 also shows the results of Example 5.

TABLE 9

| | | Average | Discharge |
|---|---|---|---|
| | | discharge | capacity |
| | | voltage (V) | (mAh/g) |
| Example 5 | Alkyl glucoside | 0.9 | 1000 |
| | (18 carbon atoms) | | |
| | aqueous solution | | |
| Comparative | Sodium chloride | 1.1 | 830 |
| Example 3 | aqueous solution | | |
| Comparative | Triton-X100 | 0.9 | 980 |
| Example 3 | aqueous solution | | |
| Comparative | Alkyl glucoside | 0.9 | 990 |
| Example 3 | (16 carbon atoms) | | |
| | aqueous solution | | |

The battery using the sodium chloride aqueous solution as an electrolytic solution had a voltage of 1.1 V and a discharge capacity of 830 mAh/g. The battery using the electrolytic solution to which Triton-X100 was added had a voltage of 0.9 V and a discharge capacity of 980 mAh/g. The battery using the electrolytic solution to which the alkyl glucoside having 16 carbon atoms was added had a voltage of 0.9 V and a discharge capacity of 1090 mAh/g. In all the comparative examples, the discharge capacities were smaller than those in Example 5.

From the above results, it was confirmed that the metal-air battery of the present embodiment was superior in discharge capacity to the metal-air battery in which an alkyl glucoside having 18 to 22 carbon atoms was not added even when zinc was used for the negative electrode.

The metal-air battery of the present embodiment described above is a metal-air battery including an air electrode 101, a negative electrode 102, and an electrolytic solution 104 disposed between the air electrode 101 and the negative electrode 102, and the electrolytic solution 104 contains an alkyl glucoside having 18 or more and 22 or less carbon atoms.

In this way, the metal-air battery of the present embodiment can suppress the corrosion reaction of the negative electrode and realize a metal-air battery having a high discharge capacity by using the electrolytic solution to which the alkyl glucoside having 18 or more and 22 or less carbon atoms is added as a surfactant.

As illustrated in FIG. 2, the metal-air battery of the present embodiment may include the ion exchange membrane 105 that separates an electrolytic solution into the positive electrode side electrolytic solution 103 and the negative electrode side electrolytic solution 104, and an alkyl glucoside having 18 or more and 22 or less carbon atoms may be contained in the negative electrode side electrolytic solution 104. Since the ion exchange membrane 105 suppresses diffusion of the alkyl glucoside, a corrosion reaction of the negative electrode 102 is suppressed by the effect of the alkyl glucoside, and since the alkyl glucoside does not permeate the ion exchange membrane 105, it is possible to prevent the air electrode 101 from being hydrophilized and submerged. Therefore, the metal-air battery including the ion exchange membrane 105 can improve battery performance by suppressing the corrosion reaction of the negative electrode 102 while minimizing the influence on the air electrode 101.

Note that the present invention is not limited to the above embodiments, and various modifications and combinations are possible within the technical idea of the present invention.

### REFERENCE SIGNS LIST

101 Air electrode
102 Negative electrode
103, 104 Electrolytic solution
105 Ion exchange membrane

1. A metal-air battery comprising:
an air electrode;
negative electrode;
an electrolytic solution disposed between the air electrode and the negative electrode,
wherein the electrolytic solution contains an alkyl glucoside having 18 or more and 22 or less carbon atoms.

2. The metal-air battery according to claim 1, further comprising an ion exchange membrane that separates the electrolytic solution into a positive electrode side electrolytic solution and a negative electrode side electrolytic solution,
wherein the alkyl glucoside is contained in the negative electrode side electrolytic solution.

3. The metal-air battery according to claim 2, wherein the ion exchange membrane contains at least two selected from the group consisting of a carbon atom, a hydrogen atom, an oxygen atom, a nitrogen atom, a sulfur atom, a sodium atom, a potassium atom, and a phosphorus atom.

4. The metal-air battery according to claim 1, wherein the negative electrode contains at least one selected from the group consisting of magnesium, zinc, aluminum, iron, and calcium.

5. The metal-air battery according to claim 1, wherein the air electrode includes a co-continuous body having a three-dimensional network structure in which a plurality of nanostructures are integrated by non-covalent bonds.

6. The metal-air battery according to claim 2, wherein the negative electrode contains at least one selected from the group consisting of magnesium, zinc, aluminum, iron, and calcium.

7. The metal-air battery according to claim 3, wherein the negative electrode contains at least one selected from the group consisting of magnesium, zinc, aluminum, iron, and calcium.

8. The metal-air battery according to claim 2, wherein the air electrode includes a co-continuous body having a three-dimensional network structure in which a plurality of nanostructures are integrated by non-covalent bonds.

9. The metal-air battery according to claim 3, wherein the air electrode includes a co-continuous body having a three-dimensional network structure in which a plurality of nanostructures are integrated by non-covalent bonds.

10. The metal-air battery according to claim 4, wherein the air electrode includes a co-continuous body having a three-dimensional network structure in which a plurality of nanostructures are integrated by non-covalent bonds.
